(19) United States
(12) Patent Application Publication
(10) Pub. No.: US 2014/0087147 A1
(43) Pub. Date: Mar. 27, 2014

(54) SELF-CORRUGATING LAMINATES AND METHODS OF MAKING THEM

(71) Applicant: Eastman Chemical Company, Kingsport, TN (US)

(72) Inventors: Marcus David Shelby, Fall Branch, TN (US); Scott Allen Clear, Escondido, CA (US); Freddie Wayne Williams, Kingsport, TN (US); Alan Yee Heng Kwok, Arcadia, CA (US); Candace Michele Tanner, Kingsport, TN (US); Jennifer Lynne Stikeleather Peavey, Raleigh, NC (US); Jeffrey Todd Owens, Kingsport, TN (US); Peter Borden Mackenzie, Kingsport, TN (US)

(73) Assignee: EASTMAN CHEMICAL COMPANY, Kingsport, TN (US)

(21) Appl. No.: 14/025,059

(22) Filed: Sep. 12, 2013

Related U.S. Application Data
(60) Provisional application No. 61/706,422, filed on Sep. 27, 2012.

(51) Int. Cl. B32B 3/28

(52) U.S. Cl. CPC B32B 3/28
USPC 428/185

(57) ABSTRACT

Self-corrugating laminates are disclosed that include first and second shrinkable film layers, each having a primary axis of shrinkage, bonded together in a grid of spaced bond points arranged substantially linearly along perpendicular horizontal and vertical bond lines such that the axes of shrinkage are substantially perpendicular to one another. Upon shrinkage of the shrinkable film layers, a structural corrugate is formed that includes first and second corrugated layers each with structural corrugations therein arranged along lines of corrugation. At the interface of the two corrugated layers, the lines of corrugation in the first corrugated layer are substantially perpendicular to the lines of corrugation in the second corrugated layer.

### RELATED APPLICATIONS

This application claims priority from U.S. Provisional Application No. 61/706,422, filed on Sep. 27, 2012, the entire disclosure of which is incorporated herein by reference.

### FIELD OF THE INVENTION

The present invention relates to laminates, and specifically, to self-corrugating laminates that are useful to form structural corrugates.

### BACKGROUND OF THE INVENTION

The ability to make structural or functional plastic panels is limited to just a few processes because of the low modulus of plastics in general, coupled with the difficulty of generating three-dimensionally-reinforced structures. The processes that are available are either labor-intensive (e.g. thermoforming and bonding) or require extensive tooling (e.g. twin wall sheet extrusion). Parts made by these methods are also typically limited to two-dimensions such as with panels and, once produced, tend to be bulky and cannot be easily shipped or packaged. It is also difficult to introduce functionality into these structures because the core material is not easily modified, being specific to the intended use. It would be an advance in the art to provide rigid, and optionally functional, structural panels that are easily produced and shipped, that may be formed as films and shipped as rolls, and that may then be expanded just prior to use to form structural corrugates. Although prior art corrugates are known in which shrinkable layers assist in forming corrugations, we have found conventional shrinkable materials unsuitable to more demanding applications in which regular, structural corrugations are required.

U.S. Pat. No. 2,607,104 discloses two-ply and three-ply woven corrugated fabrics that are said to be highly resilient in resisting lateral compression. The three-ply fabrics include a top and bottom fabric that can be shrunk or contracted in the same direction to a pronounced degree of about 50% when heated, so that the shrinking of the outer fabrics will corrugate the intermediate fabric.

U.S. Pat. No. 3,620,896 discloses a tape having at least two laminae of different coefficients of contraction joined to prevent interlamina relative movement during contraction. The contractable lamina, which may contract as much as 50 to 70 percent of its original stretched dimensions upon activation, is said to be sharply corrugated, resulting in a lack of structural rigidity needed for more demanding applications. The tapes disclosed are intended simply as devices for securing wire and cable bundles, and the like.

U.S. Pat. Nos. 3,574,109 and 3,655,502 disclose heat insulating laminates in which at least one metal foil and at least one thermoplastic resin film are bonded at a number of bonding points uniformly distributed throughout the surface. The material is heated to cause shrinkage of the resin film and wrinkling of the metal foil.

U.S. Pat. No. 3,796,307 discloses a corrugated package material in which corrugated fluting is attached to one or more sheets of heat shrinkable polymeric film. The heat shrinkable film is preferably on only one side of the corrugated fluting, but may be on both sides of the corrugated fluting. The package may be heated to shrink the polymeric film and tighten the corrugated fluting core.

U.S. Pat. No. 6,875,712 discloses a shrinkable protective material that includes a nonwoven fabric bonded to a shrinkable film by an adhesive that is applied to either the nonwoven fabric or the shrinkable film in a pre-determined pattern. Upon shrinking, the nonwoven fabric separates or releases from the film and forms cushions or pillows holding the film off of the surface being protected. Since the film shrinks and the non-woven fabric is said not to shrink in any appreciable amount, the portions of the non-woven fabric overlying the areas which are unbounded are said to gather up to form the raised portions.

U.S. Pat. No. 7,588,818 discloses a multi-layer composite sheet comprising a shrinkable layer intermittently bonded to a gatherable layer with the bonds separated by a specified distance, wherein the shrinkable layer can shrink and at the same time gather the gatherable layer between the bonds. Also disclosed is a process for preparing multi-layer composite sheets by intermittently bonding a shrinkable layer to a gatherable layer with the bonds separated by a specified distance and causing the shrinkable layer to shrink while at the same time gathering the gatherable layer between the bonds.

JP 6-115014A discloses a laminatable strip that has self-stretching properties and can be filled with gas on site without the use of an expanding gas or the like, wherein the strip is a highly self-stretchable strip that has an ultrahigh gas content and a stable structure after stretching.

JP 6-238800A discloses a laminate for forming a three-dimensional structure with holes wherein a low-heat-shrinkage sheet and a high-heat-shrinkage sheet are alternately laminated together via partially adhesive layers arranged at a pre-determined interval in a substantially striped pattern substantially perpendicular to the shrinkage direction of the high-heat-shrinkage sheet, the laminate being characterized in that the low-heat-shrinkage sheet and the high-heat-shrinkage sheet are laminated in at least five layers or more.

A related patent document having the same inventor and filing date, JP 6238796, discloses a three-dimensional accurately formed laminated body, said to be useful for obtaining a strong and stable three-dimensional structure, that is made from a low-heat-shrinking sheet and a high-heat-shrinking sheet alternatingly laminated such that there exists a difference in shrinkage between the sheets in the vertical direction, the sheets being interposed by a plurality of substantially striped partial adhesive layers disposed at a specific spacing. The laminated body is characterized in that the low-heat-shrinking sheet and the high-heat-shrinking sheet are five or more layers in total, and the partial adhesive layers are disposed alternatingly on an obverse and reverse side of the low-heat-shrinking sheet such that the spacing sequentially increases or decreases.

There remains a need in the art for improved film laminates that form structural corrugations by controlled contraction of shrinkable film layers, and especially those that form well defined corrugations in which at least two adjacent layers are provided with corrugations substantially perpendicular to one another. Such a structure would provide improved flexural stiffness in both the machine and transverse directions.

### SUMMARY OF THE INVENTION

The present invention relates to self-corrugating laminates. The self-corrugating laminates of the invention include a first shrinkable film layer and a second shrinkable film layer, each having a primary axis of shrinkage, bonded together such that the primary axes of shrinkage are substantially perpendicular to one another. The two shrinkable film layers are typically bonded together in a grid of spaced bond points arranged substantially linearly along perpendicular horizontal and vertical bond lines. Upon shrinkage of the shrinkable film layers of the self-corrugating laminate, a structural corrugate is formed therefrom. The structural corrugate includes a first corrugated layer and a second corrugated layer each with structural corrugations therein arranged along lines of corrugation with the lines of corrugation in the first corrugated layer substantially perpendicular to the lines of corrugation in the second corrugated layer at the interface of the first corrugated layer and the second corrugated layer.

In a further aspect, the invention relates to structural corrugates which comprise the self-corrugating laminates of the invention in a form in which the shrinkable film layers have been shrunk to form the linear corrugations from the two layers, which linear corrugations are substantially perpendicular to one another.

In a further aspect, the invention relates to a processes for making self-corrugating laminates that include roll-to-roll processes in which a roll of shrinkable film having its axis of shrinkage transverse to its unwind direction is unrolled and bonded to a shrinkable film unwound from a roll of shrinkable film having its axis of shrinkage parallel to its unwind direction.

Further aspects of the invention are as disclosed and claimed herein.

### BRIEF DESCRIPTION OF THE DRAWINGS

FIG. 1 is a top view of the self-corrugating laminate of the present invention with the first shrinkable layer removed to expose the grid of spaced bond points.

FIG. 2 is a side elevational view of the self-corrugating laminate of the present invention.

FIG. 3 is a perspective view of an embodiment of the structural corrugate of the present invention.

FIG. 4 depicts an edge view of an embodiment of the structural corrugate of the present invention.

FIG. 5 is perspective view of an alternative embodiment of the structural corrugate of the present invention that includes top and bottom non-shrinkable film layers.

FIG. 6 is a top view of the self-corrugating laminate of the present invention with the first shrinkable layer removed to expose a grid of spaced bond points having variable bond spacing.

### DETAILED DESCRIPTION

Unless otherwise indicated, all numbers expressing quantities of materials or ingredients, properties such as percent shrinkage, and so forth used in the specification and claims are to be understood as being modified in all instances by the term “about.” Accordingly, unless indicated to the contrary, the numerical parameters set forth in the specification and claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C1 to C5 hydrocarbons”, is intended to specifically include and disclose C1 and C5 hydrocarbons as well as C2, C3, and C4 hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used herein, the term “shrinkable film layer” means a film layer that is capable of shrinking once bonded to an adjacent film layer, for example by heat shrinking. The term is not intended to be especially limiting, although we have found, as further described below, that a relatively small amount of shrinkage may yield the best results in terms of uniformity of the structural corrugations obtained. As further set out below, the shrinkage may be substantially uniaxial but may also be somewhat biaxial, so long as the shrinkable film layer has a primary axis of shrinkage. The amount of shrinkage may vary throughout the surface of the film layer, and such variation may be matched to variations in the axes of shrinkage of adjacent shrinkable film layer, so long as the primary axis of shrinkage of two adjacent film layers are substantially perpendicular to one another. Any suitable film capable of shrinking, for example heat-shrinkable film, may be used according to the invention, as further described herein.

When we refer to an “axis of shrinkage” we mean the direction in which the shrinkable film layer shrinks or shortens when the shrinkable film layer is shrunk. In uniaxial film, there will be a single axis of shrinkage, and biaxial films will have two axes of shrinkage. As used herein, the term “primary axis of shrinkage” means the axis along which the greatest amount of shrinkage occurs (note that for equi-biax films the first and second axes of shrinkage exhibit approximately the same levels of shrinkage such that either may be deemed “primary”).

As used herein, the term “non-shrinkable film layer” used to describe optional additional film layers is not intended to exclude films that shrink, but rather, to describe film layers that shrink, if at all, substantially less than do shrinkable film layers. In some embodiments, the non-shrinkable film layer may not shrink appreciably during use, while in others the non-shrinkable film layer may shrink to some extent, either uniformly or to correspond to a desired final shape which is obtained in combination with the appropriate spacing and placement of bond points. In various aspects, the amount of linear shrinkage of the non-shrinkable film layer may be less than about 10%, or less than 5%, or less than 1%, or as further set out herein.

As used herein, the term “structural corrugations” means corrugations present in a corrugated layer of the structural corrugate and formed through shrinking of the shrinkable film layers in the self-corrugating laminate of the present invention. These structural corrugations are generally capable of providing structural integrity and/or load-bearing structural support and can be distinguished from weak and typically irregular and/or wavy lines that may be suitable, for example, to provide an insulating layer or bulk in cases where load-bearing structural support is not required, and the corrugations need not therefore be carefully controlled as is done according to the present invention. The phrase structural corrugation is further elaborated on below, in particular with respect to the description of aspect ratio (Hc/P).

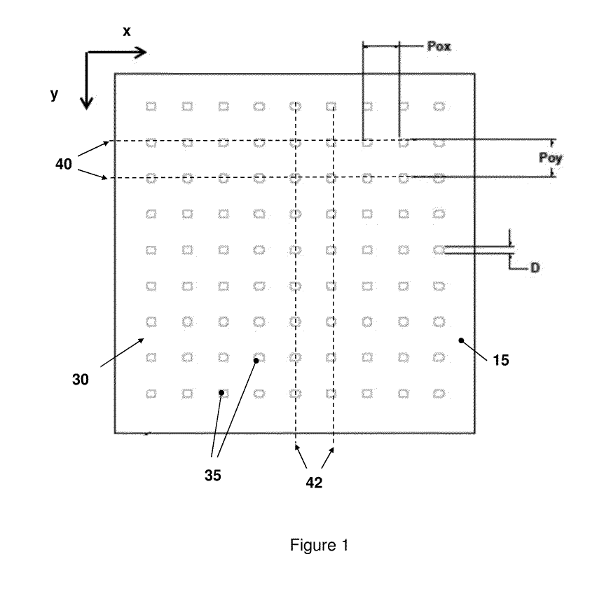

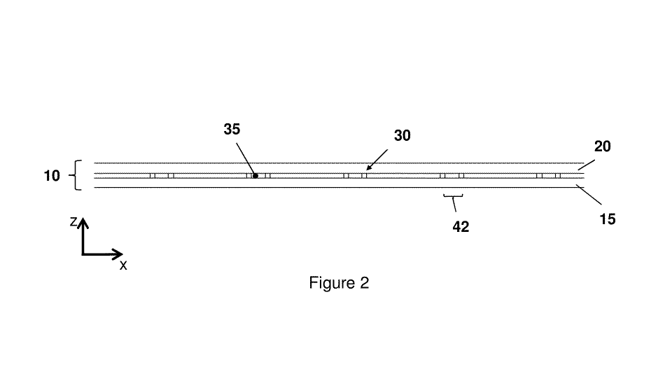

The present invention relates to self-corrugating laminates. As shown in FIGS. 1 and 2, the self-corrugating laminate 10 includes at least a first shrinkable layer 15 and a second shrinkable film layer 20, each having a primary axis of shrinkage, which are bonded together such that the primary axis of shrinkage of the first shrinkable layer is substantially perpendicular to the primary axis of shrinkage of the second shrinkable film layer. In FIGS. 1, 2 and 6, the primary axis of shrinkage for layer 15 is in the x (or horizontal) direction and the primary axis of shrinkage for layer 20 is in the y (or vertical) direction. The two shrinkable film layers 15 and 20 are typically bonded together in a grid 30 of spaced bond points 35 spaced at spacing Po and arranged substantially linearly along perpendicular horizontal (or X-direction with spacing Pox as shown in FIG. 1) and vertical (or Y-direction with spacing Poy as shown in FIG. 1) bond lines 40 and 42 respectively. It will be understood by one of ordinary skill that terminology such as horizontal, vertical, X-direction and y-direction are used herein to describe relative orientation as shown in the Figures and that they are dependent on the drawing orientation and viewer perspective.

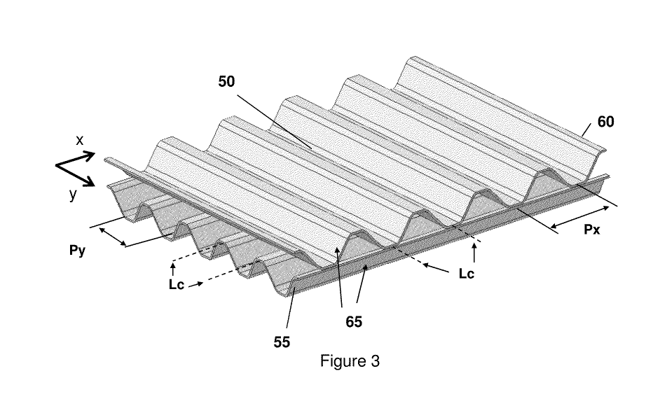

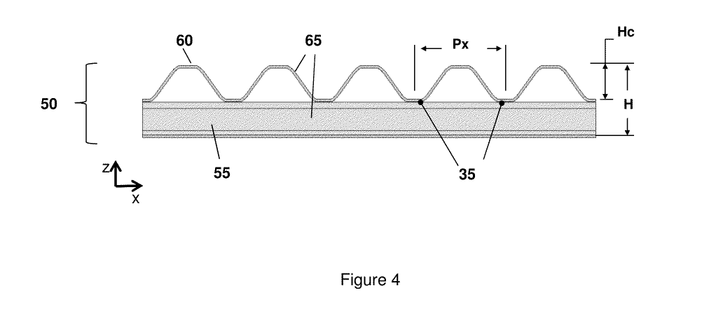

As described below and shown in FIGS. 3 and 4, the self-corrugating laminates 10, after shrinking of the shrinkable film layers, form structural corrugates 50. The structural corrugate therefore includes first and second corrugated layers 55 and 60 each with structural corrugations 65 therein arranged along lines of corrugation Lc. At the interface of said first corrugated layer 55 and said second corrugated layer 60, the lines of corrugation in said first corrugated layer 55 are substantially perpendicular to said lines of corrugation in said second corrugated layer 60. This two-layer corrugated structure may be described as a “corrugation module” or a “base corrugation model,” and is the simplest and most basic form of the present invention. These corrugation modules can, in turn, be combined together or modified to create additional structures.

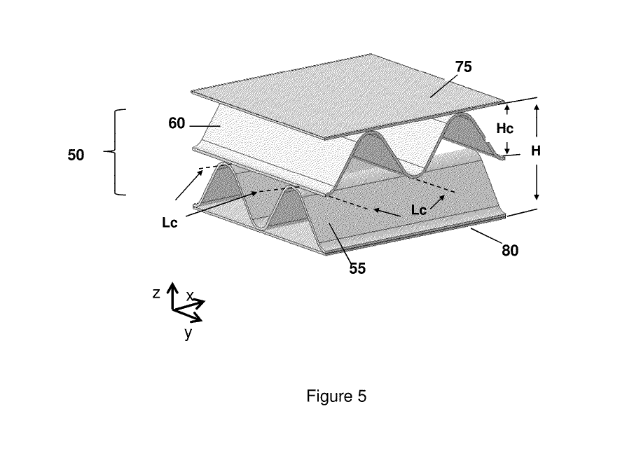

The structural corrugates of the invention may optionally have any number of additional layers. For example, top and bottom layers are denoted in FIG. 5 by 75 and 80 respectively. These additional layers, or additional film layers, may be shrinkable film layers or non-shrinkable film layers, added on or attached to either of the two corrugated layers of the structural corrugate or the shrinkable film layers of the self-corrugating laminate. The shrinkable film layers for any additional film layers may be substantially perpendicular to a primary axis of shrinkage of an adjacent film layer as disclosed and claimed herein. Alternatively, additional film layers may be biaxial shrinkable film layers in which shrinkage occurs both substantially parallel to and substantially perpendicular to the axis of shrinkage of an adjacent film layer. In yet another alternative, additional film layers may be non-shrinkable film layers which may form corrugations due to shrinkage of an adjacent shrinkable film layer to which they are bonded, such as one of the at least two shrinkable film layers of the base corrugation module of the invention.

We have unexpectedly discovered that a self-corrugating laminate may be formed from at least two shrinkable film layers each having a primary axis of shrinkage, bonded to one another such that the primary axes of shrinkage of adjacent film layers are substantially perpendicular to one another. As shown in FIGS. 1, 2 and 6, the two shrinkable film layers are typically bonded together in a grid 30 of spaced bond points 35 arranged substantially linearly along substantially perpendicular horizontal and vertical bond lines 40 and 42 respectively. The grid 30 includes rows and columns of bond points spaced and laid out in a substantially linear fashion. The phrase “substantially linearly” is meant to include arrays in which the bond points define a strict bond line as well as cases in which the bonds may not define a strict line, but rather may vary somewhat along a linear array, so long as the desired corrugations and structural corrugate are obtained. The phrase “substantially perpendicular” as used to describe bond line arrangement as well as axes of shrinkage relationship is meant to include those cases in which the axes or bond lines are absolutely perpendicular, as well as cases in which the axes or bond lines may not be entirely perpendicular, and may vary along the length of a given axis, so long as the orientation of the axes and bond lines are sufficient to induce the desired perpendicular orientation of the resulting corrugations and/or lines of corrugation in each corrugated layer. Of course, the degree in which the bond points are laid out in a linear fashion will correspondingly affect the degree of linearity of the resulting linear corrugations. We mean simply to encompass laminates in which the bond point arrangement and/or bond line and shrinkage axes perpendicularity are not absolutely geometric, so long as the desired result is obtained.

When the two shrinkable layers are subjected to conditions sufficient to activate their shrinkage, corrugations are formed in each layer thereby forming a structural corrugate 50 with first and second corrugated layers 55 and 60. The corrugations 65 in each corrugated layer are arranged along lines of corrugation Lc that are themselves perpendicular to one another at the interface of the two corrugated layers 55 and 60, forming a cross-ply structural corrugate. The resulting cross-ply structural corrugate has the benefit of being more rigid in both the machine direction (MD) and transverse direction (TD) as compared with the structures of the prior art. Structural corrugates 50 are thereby formed and include first and second corrugated layers 55 and 60 each with structural corrugations 65 therein arranged along lines of corrugation Lc. The lines of corrugation Lc in said first corrugated layer 55 are substantially perpendicular to the lines of corrugation Lc in the second shrinkable layer 60 at the interface of corrugated layers 55 and 60.

Referring now to FIGS. 1, 4 and 5, it can be seen that the bond point spacings Pox and Poy in the self-corrugating laminate will, with shrinkage of the shrinkage of the shrinkable layers, decrease to form corrugation spacings Px and Py respectively in the structural corrugate. The height of each corrugation 65 is denoted by Hc with the total thickness H of the structural corrugate 50 generally equal to 2Hc.

The present invention thus relates to self-corrugating laminates that include first and second shrinkable film layers, each having a primary axis of shrinkage, bonded together such that the primary axis of shrinkage of the first shrinkable film layer is substantially perpendicular to the primary axis of shrinkage of the second shrinkable film layer. The two shrinkable film layers are bonded together in a grid of spaced bond points arranged substantially linearly along perpendicular bond lines. Upon shrinkage of the shrinkable film layers to form corrugations in each corrugated layer, the lines of corrugation in the first corrugated layer 55 are substantially perpendicular to the lines of corrugation in the second corrugated layer 60 at the interface of corrugated layers 55 and 60.

In a first embodiment of the self-corrugating laminate of the present invention, shown in FIG. 1, the spacing Pox between the spaced bond points 35 along the horizontal (x-direction) bond lines 40 is substantially the same as the spacing Poy between said spaced bond points 35 along the vertical (y-direction) bond lines 42. In this embodiment, the height Hc of the structural corrugations 65 in the first corrugated layer 55 of the resulting structural corrugate 50 is approximately equal to the height Hc of the structural corrugations 65 formed in the second corrugated layer 60 of the resulting structural corrugate 50 as shown in FIGS. 3, 4 and 5.

In another embodiment the spacing Po between the bond points along the horizontal bond lines is greater than the spacing between the bond points along the vertical bond lines, that is, Pox differs from Poy. In this embodiment, a structural corrugate 50 may be formed wherein the height Hc of the structural corrugations in the first corrugated layer 55 is greater than the height Hc of the structural corrugations 65 formed in the second corrugated layer 60.

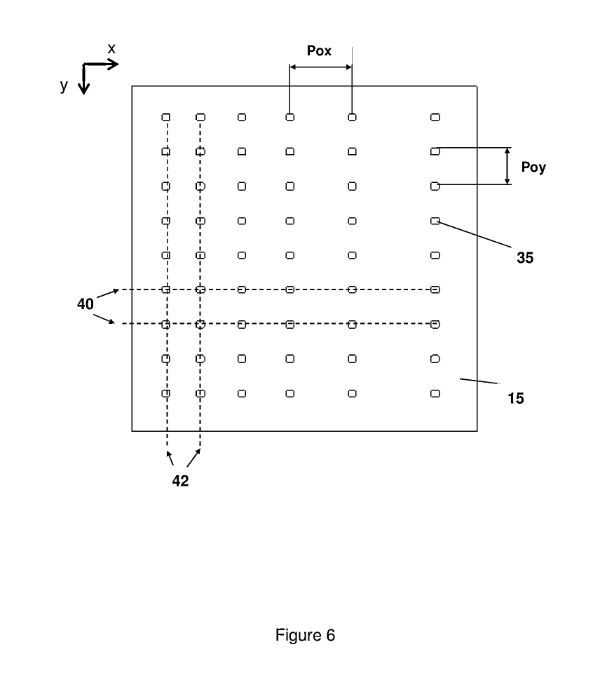

In a further aspect, the spacing Po between the bond points along at the least one of the horizontal bond lines 40 or the vertical bond lines 42 may optionally vary, such that the height Hc of the resulting structural corrugations perpendicular to that direction as well as the total height H of the structural corrugate likewise may vary in corresponding fashion. By way of example, for the embodiment shown in FIG. 6 and described in Example 8, the bond point spacing Pox varies along horizontal bond line 40. In this embodiment, the height of the structural corrugations in the resulting structural corrugate vary within at least one of the first corrugated layer and the second corrugated layer.

The bond point spacing is thus selected based on the desired size and shape of the corrugations to be formed, with the generally linear array of bond points resulting in generally linear lines of corrugation. Wider spacing of the point bonds leads to structural corrugations perpendicular to that spacing having a greater height, while closer spacings will result in corrugations perpendicular to that spacing having a relatively lower height, as further described herein, with corrugations formed which are substantially parallel with the axis of shrinkage of a given shrinkable film layer, and with the height of the corrugation depending upon the distance between the bonds in the direction perpendicular to the primary axis of shrinkage of a given shrinkable film layer.

In various aspects of the invention, the shrinkable film layers may be comprised of a variety of film materials with the material for each layer individually selected from a variety of polymer components having selected physical properties such as glass transition temperature, tensile modulus, melting point, surface tension, and melt viscosity. Examples include one or more of a polyester, a copolyester, an acrylic, a polyvinyl chloride, a polylactic acid, a polycarbonate, a styrenic polymer, a polyolefin, a polyamide, a polyimide, a polyketone, a fluoropolymer, PVC, a polyacetal, a cellulose ester or a polysulfone. Shrinkable film layers may also comprise, for example, polyesters of various compositions. For example, amorphous or semicrystalline polyesters may be used which comprise one or more diacid residues of terephthalic acid, naphthalene-dicarboxylic acid, 1,4 cyclohexane-dicarboxylic acid, or isophthalic acid, and one or more diol residues, for example ethylene glycol, 1,4-cyclohexane-dimethanol, neopentyl glycol, or diethylene glycol. Additional modifying acids and diols may be used to vary the properties of the film as desired. In a preferred embodiment, shrinkage of the shrinkable film layers is activatable by elevated temperature or heating.

It is also understood that the shrinkable film layers, while preferably formed from a continuous material, can also be formed from discontinuous materials such as a nonwoven web or woven fabric as long as the layers have shrinkage properties as set out in this invention and exhibit sufficient integrity to form structural corrugations upon activation of shrinkage.

The thickness used for the shrinkable film layers can range, for example, from 0.01 mm to 10 mm. Because of the potential for excessive wrinkling at thinner gauges, it may be preferred that the thickness range from 0.05 to 5 mm, or more preferably from 0.1 to 5 mm, or even more preferably from 0.2 to 2 mm. For applications requiring shrinkable film layer thicknesses at the lower end of this range, very thin films, bond point spacing must be reduced and shrinkage temperature carefully controlled in order to eliminate wrinkling.

The shrinkable film layers of the present invention may exhibit a wide range of shrinkage along the primary axis of shrinkage. The shrinkable film layers typically are each characterized by a percent shrinkage as calculated below in the range of about 8% to about 48%, preferably 10 to 45%, more preferably 15 to 40%, and even more preferably 20 to 40% as measured along the primary axis of shrinkage of the shrinkable film layer. Percent shrinkage, as the phrase is used herein, is defined as the percentage of length lost upon activation of shrinkage, for example by heating, using the following formula:

Percent shrinkage=(Lo−L)/Lo*100 (1)

wherein L is the length of the film after shrinkage, and Lo is the length prior to shrinkage. Shrinkage refers to the amount of shrinkage obtainable in a single direction and may be measured in heat-shrinkable film by heating the film to a temperature sufficiently above the Tg (or the melting temperature Tm, if crystalline) to allow substantially complete recovery of the film. By the term “length,” we mean generally the primary direction in which, for example, a heat-shrinkable film layer was formed, although such a film may be stretched biaxially or radially, for example. We note that an equibiaxially oriented film and a radially stretched film are essentially equivalent from a mechanical perspective. Uniaxial film can be formed by stretching in the machine direction with, for example, a drafter or calender, or in the transverse direction with a tenter frame. Combining the two processes results in biaxially-oriented film. Some processes, like blown film provide shrinkage in both the machine and transverse direction simultaneously, although the shrinkage is usually much higher in one direction. The length may thus be in the shrinkage direction of axis of shrinkage for uniaxial film and either or both directions when biaxial film layers are described. Although most commercial shrink films used for packaging have an ultimate or total shrinkage of 60 to 80%, we have found that high shrinkage from these conventional films produces poorly formed and uncontrolled corrugations (i.e. “wrinkling” or “overbuckling”). As a result of much experimentation and analysis, it was unexpectedly discovered that a defined range of shrinkage that produces the most desirable structural corrugates are as set forth above. Outside of these ranges, either wrinkling or insufficient buckling may occur, such that it may be difficult to create stable and consistent structural corrugations. Even in cases where we were able to achieve acceptable structures using high shrinkage shrinkable film layers, by only partially shrinking the shrinkable film layers, the resulting structures were not thermally stable as any additional heating would cause the corrugation to be disrupted by further shrinkage.

We note that the shrinkable film layers 15 and 20 need not exhibit the same percent shrinkage, especially if curved structures are desired. For example, a first shrinkable film layer discontinuously bonded to a second shrinkable film layer may have about 10% shrinkage, while the second shrinkable film layer may have about 20% shrinkage. In such cases, differential shrinkage may be an important aspect of obtaining curved structural corrugates. The difference in shrinkage between the first and second shrinkable layers along their primary axes of shrinkage can thus be used to control the radius of curvature.

Curved or 3-D structures can also be generated by forming or shaping the self-corrugating laminate or structural corrugate using a mold or guide tooling. This can be done as part of the shrinkage process, where the part is pushed into a new geometry as it shrinks and corrugates. Alternately, the corrugated sheet can be shaped in a secondary operation using, for example, a thermoforming process.

The bond points 35 may be formed in a variety of ways. For example, bond points 35 may include an adhesive and therefore be adhesive bonds formed by use of an adhesive or adhesive tape. Typical adhesives that may be used include epoxies, urethanes, hot melts, acrylic-based adhesives, UV-activated adhesives, cyanoacrylates, and the like. Alternatively, the bond points 35 may comprise welds formed by for example RF sealing, ultrasonic bonding, laser welding, heat/thermal welding, induction welding or solvent welding. Additionally, bond points 35 may be mechanical connectors such as rivets, staples, stitching or similar type mechanical fastening devices.

Although the self-corrugating laminate of the present invention has been described and illustrated as including first and second shrinkable layers, it should be understood that the self-corrugating laminate may further include any number of additional shrinkable film layers that may, depending on the intended use, be bonded such that the axes of shrinkage of the shrinkable film layers are parallel, perpendicular, or some combination of the two, as the case may be. Thus, if additional shrinkable film layers are provided which are substantially uniaxial, and parallel corrugations in adjacent layers are desired to be produced upon shrinkage, at least a portion and preferably a substantial portion of the bond lines may be placed substantially perpendicular to the axis of shrinkage of the adjacent shrinkable film.

According to one aspect of the invention, particularly uniform and strong structural corrugates may be characterized by an aspect ratio that preferably is indicative of a substantially sinusoidal pattern. The aspect ratio is defined as the ratio Hc/P where Hc is the height of a given structural corrugation in a corrugated layer and P is the corrugation spacing in either the x or y direction (Pₓ or P_{y}) (analogously, Hc is twice the amplitude of the sine wave represented by the corrugation and P is the corrugation wavelength). If Hc/P is too large, then the resulting corrugation is very “tall” and closely packed to adjacent corrugations resulting in a more unstable structure with adequate compressive strength (i.e. top load) but less than desirable shear resistance. This is typical of the corrugations formed when shrinkage of the shrinkable film layers is undesirably high. Conversely, if Hc/P is too low, the corrugation is too shallow and widely spaced from adjacent corrugations and provides little compressive strength from top loads (but good shear resistance). For uniform structural corrugates, the aspect ratio is generally the same within and across its corrugated layers. It should be understood, however, that because Pₓ, P_{y} and Hc can all vary within a structural corrugate, the ratio of Hc/P (i.e. H_{c}/Pₓ or H_{c}/P_{y}) can also vary such that a structural corrugate of the present invention may be characterized by multiple aspect ratios.

Preferred structural corrugates of the present invention have aspect ratios of preferably within the range of from about 0.1 to about 0.8 according to the following formula:

0.1<Hc/P<0.8 (2)

A more preferred range for the aspect ratios is from about 0.2 to about 0.6, as this range is applicable to a structural corrugate formed from a self-corrugating laminate with shrinkable film layers having shrinkages of from about 15% to about 40%.

The present invention thus provides a way to make a structural corrugates from a preformed, preferably substantially flat self-corrugating laminate that preferably can be rolled for ease of shipping and storage and then unrolled and processed as needed to form structural corrugates. More particularly, the present invention in one aspect includes a method of making a self-corrugating laminate comprising (i) providing first and second shrinkable film layers each with a primary axis of shrinkage and (ii) bonding the first and second shrinkable film layers such that the primary axis of shrinkage of the first shrinkable layer is substantially perpendicular to the primary axis of shrinkage of the second shrinkable film layer. More preferably, the providing step includes feeding first and second shrinkable film layers from rolls to form a sheet assembly.

It is to be understood that the structural corrugates of the present invention may be modified after formation to suit particular end uses. For example, as shown in FIG. 5, the structural corrugate may include non-shrinkable layers 75 and 80 to provide aesthetic, protective or other functions. Non-shrinkable layers 75 and 80 may be formed from a variety of suitable materials, thus facilitating creation of a variety of different functional structures can easily and cheaply be produced for a wide range of different applications. For example, a non-shrinkable layer may be printed with aesthetically pleasing designs, or functional patterns such as those used for electrical applications (e.g. built in wiring or electromagnetic shielding). Suitable materials for the non-shrinkable film layer may include a plastic film such as a copolyester, polyester, acrylic, olefin, polycarbonate, polyimide, cellulose ester, polyamide, styrenic, urethane etc. Other possible materials include thermoset or a thermoplastic plastics however, the material is not limited to plastics or polymers, and may also be a metal foil, paper, a non-woven, a fabric, a fiber or mineral reinforced material, and so forth. The non-shrinkable film layer may also be selected to provide a desired functionality.

As discussed above, the structural corrugates of the present invention may also be shaped to form a curved corrugate, such as by conventional molding processes, after being formed from the self-corrugating laminate.

Construction of the self-corrugating laminates of the present invention and their components can be achieved using a variety of methods of materials. Typically, conventional film or sheet extrusion may be used to form the film layers, including the shrinkable film layers and any optional non-shrinkable film layers. This can be achieved, for example, by cast extrusion, sheet polishing, blown film, calendering or other film manufacturing methods known to one of ordinary skill.

The shrinkable film layers of the present invention are produced from known or conventional materials as exemplified above and which are or can be modified or treated to be capable of shrinkage. In the preferred embodiment wherein shrinkage of the shrinkable film layers is activatable by elevated temperature or heating, the shrinkable film layers will be oriented. The term “oriented”, as used herein, means that the shrinkable film layer is stretched to impart direction or orientation in the polymer chains. Orientation can be achieved by traditional stretching on a tenter, drafter or blown film, or it can be imparted as part of a traditional process such as calendering. The properties of the final product depend on and can be controlled by manipulating the stretching time and temperature and the type and degree of stretch. The stretching typically is done just above the glass transition temperature (e.g., Tg+5° C. to Tg+60° C.) of the polymer matrix. Because the present invention may be characterized in preferred embodiments by shrinkable film layers with the shrinkages set forth above, it is also possible to make sufficiently oriented films on, for example, a traditional cast line, by using high draw down speeds and rapid quenching of the film.

For the first and second shrinkable film layers in which the primary axes of shrinkage are perpendicular, the shrink films are stretched primarily uniaxially. Excessive shrinkage along a secondary axis may make it more difficult to control corrugation. Any other optionally included shrink films can be stretched uniaxially or biaxially, and the biaxial orientation can be equibiax or non-equibiax. Non-equibiax films that stretch a different amount in each of two different directions, can be useful for creating unusually curved structural corrugates. In a preferred embodiment the shrinkable film layers are uniaxially oriented and therefore have a singular axis of shrinkage.

In another embodiment, one or more of the shrinkable film layers is formed from a stretchable material which is restrained in a stretched configuration while bonding to the other shrinkable film layer occurs. Suitable materials for forming the shrinkable film layers in this embodiment include rubbers such as natural rubber, styrene-butadiene rubber, thermoplastic elastomers, stretchable fabrics and the like. In this embodiment, shrinkage of the shrinkable film layer is activated by releasing the restraint that holds the layer in a stretched configuration.

The shrinkable film layers may optionally have surface texture, grooves or thickness variations imparted, for example, using lenticular casting rolls, embossing, or post-extrusion modification. Examples include (1) a thin spot or cut in the shrinkable film layers at certain locations to allow for easier and more controlled buckling and (2) a continuous undulating variation imparted via lenticular embossing rolls. Having thin spots or grooves in the shrinkable film layers, particularly on the opposing side from the bond points, can allow the film to buckle during corrugation formation with less shrink force. This may be advantageous particularly with thicker shrinkable film layers. Grooves and embossed patterns can also be beneficial for aiding bonding along bond lines with bond points formed with ultrasonic staking as they allow the shrinkable film layer to buckle and corrugate with less shrink force. This may be advantageous particularly with very thick shrinkable film layers. Further, it has been found that the shrinkable film layers may be modified to facilitate corrugation by forming flutes therein to give room for corrugation and contraction. As the material shrinks and pulls in, the flutes pull together and close the gap resulting in a more continuous structure.

In a preferred embodiment wherein bond points are welds, the bond points may further include creases or grooves formed therein, for example with an ultrasonic or RF welding die. For example, the stamping and heating action of an RF sealing die imparts a small indentation at the bond point that can be used to help guide corrugation. Smaller indentations or grooves can be incorporated at various points by modification of the RF die.

For embodiments wherein bond points are formed with adhesives or solvents, grooves may optionally be added to the shrinkable film layers to help keep the adhesive or solvent within a specific area and prevent “squeeze-out” when the layers are pressed together. Other modifications such as pre-creasing, slitting, scoring, die-cutting, thermal pre-forming, etc., might also be used to aid in guiding formation of the corrugations in certain applications. Similarly, the use of selective heating to soften certain points along the shrinkable film layers may be beneficial, as softening the material has the same effect as reducing the local thickness. Further, dyes or other electromagnetic radiation absorbers might be selectively added/printed on certain sections of the structure to make those regions heat up more, to further control the corrugation process. In one embodiment, the adhesive itself used to form the bond points includes a radiation absorbing additive or is otherwise modified to increase its propensity to absorb radiation, thereby reducing the modulus of the adjacent film layer upon heating thereby reducing resistance to buckling.

Optional non-shrinkable layers will typically have thicknesses will range from about 0.01 to 10 mm, but even thicker values can be envisioned, particularly if of a lower modulus (e.g. foams, rubbery materials). The film may also contain any of a number of normal additives and processing aids, colorants, pigments, stabilizers, antiblocks, etc. as long as these do not adversely affect subsequent bonding. Multilayer coextruded or laminated structures can also be useful, particularly for adding additional functionality to the overall structure.

The present invention further relates to a method for forming a structural corrugate. This method of the present invention includes procuring, for example through manufacture or commercial transaction, a self-corrugating laminate including first and second shrinkable film layers and subjecting the self-corrugating laminate to conditions sufficient to activate shrinkage of the shrinkable film layers. Preferably, the subjecting step includes exposing for a suitable time the shrinkable film layers of the self-corrugating laminate to a temperature sufficient to cause shrinkage of both shrinkable film layers. Typically, this temperature is a temperature at or above the shrinkage temperature of both shrinkable film layers assuming for convenience and without limitation that the shrinkable film layers are formed from the same material. By way of example, the temperature for the exposing step should preferably be in the range of Tg−10° C. to about Tg+30° C. where the Tg is the glass transition temperature of the material used to form the shrinkable film layers. Higher temperatures will also provide good quality corrugation, but greater care must be taken to ensure uniform heating in order to minimize curling/warping. To achieve desirably uniform corrugation without the need for guide tooling, it is preferred that lower temperatures and longer exposure times be used to slow down the corrugation process and minimize folding or curling. The optimal range for this is typically from Tg−10° C. to Tg. If different materials are used in forming each shrinkable film layer, the temperature for the exposing step is preferably set based on the highest Tg between and amongst the shrinkable films.

The step of exposing the shrinkable film layers of the self-corrugating laminate to a temperature causing them to shrink can be effected by any suitable means and/or media known in the art, for example hot air exposure, immersion in a hot fluid, steam exposure, etc. It is also possible to employ in the exposing step electromagnetic field methods such as IR, electromagnetic or conductive heating in embodiments where the shrinkable film layers are formed from a material sufficiently susceptible to temperature increases via an imposed energy source. By way of example, the presence of an IR absorber as a component of the shrinkable film layers might promote shrinkage of the shrinkable film layers when exposed to infrared heaters.

For embodiments where a curved or otherwise shaped corrugated structure is desired, the process for forming the structural corrugate can further include shaping the structural corrugate. In a first embodiment the shaping step is performed simultaneously with the temperature exposure step, most preferably with the temperature exposure step performed in the presence of a mold or other shaping device which shapes the overall structure while not impacting the shrinkable film layer shrinkage (and corrugation) achieved by the temperature exposure step. We have observed that a particularly suitable structural corrugate can be achieved when the self-corrugating laminate is placed in a hot mold and allowed to form with only very light mold pressure to guide the overall structure. In this situation, shrinkage of the shrinkable film layers is activated by the elevated temperature of the mold and occurs simultaneously with molding as the overall structure softens and is pushed against the mold tooling. In another embodiment, the shaping step is performed separate from and subsequent to the temperature exposure step.

It will be understood by one of ordinary skill that composite structural corrugates that include two or more individual structural corrugates of the present invention may be contemplated. For example, a composite corrugated “stack” that includes multiple structural corrugates, with each structural corrugate formed from the self-corrugating laminate of the present invention, can be formed. The individual structural corrugates can be built together as a continuous stack or be individual structural corrugates laminated together. Furthermore, each corrugate in the stack can have differing geometries and/or preferred orientations from others. For example, one corrugate in the stack might be oriented perpendicular to another in a cross ply configuration, or at 45 degree angles in a bias ply in order to provide more flexural rigidity. Depending in part on the orientation of the individual corrugates, a stack may be subjected to corrugation conditions as a single unit that incudes multiple corrugated structures. Alternatively, individual corrugates can be subjected to corrugation conditions separately and then bonded or laminated together to form a stack.

There are numerous structural and functional applications of such a structure and the above list is not meant to be limiting. Instead, the self-corrugating structures are meant to be building blocks to enable a wide range of new structures and allow for an entirely new manufacturing method.

### EXAMPLES

The following experimental methods were used to characterize the shrinkable film layers, self-corrugating laminates and structural corrugates.

Shrinkage was determined by immersing a 100 mm×100 mm sample of the shrink film sample in water at 95° C. Hot water was used because copolyester shrink films (Tg=72° C.) were used for the experiments. Film was held in the bath for at least 30 seconds to ensure full shrinkage was complete. The length of the sample was then measured and the shrinkage in each direction determined by the following formula:

Percent shrinkage=(Lo−L)/Lo*100 (1)

in which L is the length in mm after shrinkage and Lo is the initial length (100 mm). For shrink films having a Tg>100° C., hot water can no longer be used, so either hot oil or hot air is required. For these tests, the temperature of shrinkage should be at least Tg+20° C. and the sample held until full shrinkage is acquired. This is typically about 30 seconds for liquid media and 1 minute for hot air ovens.

### Example 1

### Production of a Basic Structured Corrugation Module

For this example, a uniaxially stretched copolyester film made from Eastman Embrace LV™ (Eastman Chemical Company, Kingsport, Tenn.) was used as the shrinkage film for each of the shrinkable film layers of the self-corrugating laminate. This resin is commonly used for shrink packaging and has a Tg=72° C. To make the shrinkable film, a cast film 0.35 mm thick was extruded to create the unoriented base material. This film was then stretched 1.75× on tenter frame at a nominal temperature of 82° C. resulting in an ultimate shrinkage of 40% and a final thickness of 0.22 mm.

Two square pieces of film were cut having nominal dimensions of 150×150 mm. The films were crossed so that the shrink axes were perpendicular to each other and spot bonded at 25.4 mm intervals (Pₒ=Pₒₓ=P_{oy}=25.4 mm) using pieces of 3M UHB™ tape nominally 5 mm square. After tape was applied, the layers were pressed together in a Carver press using light pressure to ensure good adhesion.

Upon completion of the base structure, the sample was then exposed to steam to active shrinkage of the shrinkable film layers and induce corrugation. The steam was supplied by a modified paint stripper plumbed into a metal pot. The film sample was placed into the steam pot, and allowed to shrink/corrugate for about 15 to 30 seconds. Upon removal, the sample was observed to have nice, well-defined corrugation with a new periodic spacing Pₓ=P_{y} 20 mm and a corrugation height H_{c}=8 mm. The sample was both flexurally rigid and aesthetically pleasing.

### Examples 2-5

### Additional Structural Corrugates (Corrugation Modules)

The structural corrugates of these examples were produced in the same manner as Example 1, except different film samples were used. The shrinkable films used in Examples 2 and 3 both had a thickness of 0.43 mm but shrinkages were 18 and 25% respectively. The structural corrugates formed using these shrinkable films, when exposed to steam in the manner described in Example 1, produced good quality structural corrugates.

The structural corrugates of Examples 4 and 5 were produced in the same manner as Example 1 using 0.17 mm-thick shrinkable film having 25% shrinkage. The structural corrugates in both Examples 4 and 5 exhibited good corrugation, though the structural corrugate of Example 4 had some wrinkling likely due to the film being fairly thin and heating rapidly. For Example 5, the shrinkable film was pre-folded prior to heating to form creases along the corrugation peaks and valleys. This made it easier for the film to quickly buckle into the desired shape and minimized wrinkling.

### Example 6

### Corrugation Stack with Non-Shrinkable Outer Layers

This example was identical to Example 1 except that, after activating shrinkage of the shrinkable film layers to form the structural corrugate, a 0.2 mm unoriented skin layer made from Eastman Tritan™ copolyester was attached to the top and bottom surfaces of the Example 1 structural corrugate. Bonding was performed using strips of UHB™ tape across the peaks of the corrugation on either side. This resulted in an aesthetically pleasing structure with a flat layer on each side (similar to FIG. 5).

### Example 7

### Module Produced by Thermal Welding

This self-corrugating laminate of Example 7 was assembled in manner identical to that of Example 1 except the bond points were produced by thermal welding using a soldering iron. The shrinkable film used for each shrinkable film layer was 0.61 mm thick and had a shrinkage of 40%. Upon heating with steam, a well-defined, very rigid structural corrugate was produced.

### Example 8

### Variable Bond Spacing

This self-corrugating laminate of Example 8 was assembled in a manner identical to that of Example 7 except that the bond spacing Pₒₓ was varied along the horizontal bond lines, starting from 25.4 mm at a first edge of the film and increasing to 38.1 mm at a second edge of the film as shown in FIG. 6. Bond spacing in the vertical or y direction (P_{oy}) was fixed at 25.4 mm along the vertical bond lines 42 over the whole sample. Upon shrinkage of the shrinkable film layers, the corrugations aligned parallel to the x axis, had corrugation spacing of P_{y}=20 mm and a height H_{c}=8 mm that was constant over the whole structure. In contrast, the corrugations perpendicular to the x axis—had variable Pₓ and H_{c} because of the varying bond point spacing. Near the edge that had the smaller bond point spacing (i.e. Pox=25.4 mm) the resulting structural corrugation parameters were Pₓ=20 mm and H_{c}=8 mm. Moving from the firstedge toward the second edge, corrugation height and spacing increased progressively across the film reaching a maximum value of Pₓ=30 mm and H_{c}=12 mm on the second edge (i.e. Pox=38.1 mm). The net effect was a structural corrugate that varied in total thickness across its horizontal or x-direction from one side to the other.

### Example 9

### RF Sealed Module

In the self-corrugating laminate and structural corrugate of Example 9, the shrinkable films layers formed from the shrinkable film of Example 1 was bonded using a 10 kW Kabar RF sealer. A brass die tool was used having a spacing Pox=Poy=31.8 mm between weld points and producing a total laminate surface area of 305 mm×305 mm. The weld spot is generally square-shaped and 5 mm across with the corners radiused 0.8 mm to eliminate sharp edges that might tear the film. The RF sealing results in desirably strong and uniform bond points which improved the strength and consistency of the resulting structural corrugates when the self-corrugating laminate was exposed to steam.

That which is claimed is:

1. A self-corrugating laminate comprising first and second shrinkable film layers, each having a primary axis of shrinkage, bonded together in a grid of spaced bond points arranged substantially linearly along perpendicular horizontal and vertical bond lines such that said primary axis of shrinkage of said first shrinkable layer is substantially perpendicular to said primary axis of shrinkage of said second shrinkable film layer.

2. The self-corrugating laminate of claim 1, wherein upon shrinkage of said shrinkable film layers, forms a structural corrugate comprising a first corrugated layer and a second corrugated layer each with structural corrugations therein arranged along lines of corrugation, wherein at the interface of said first corrugated layer and said second corrugated layer said lines of corrugation in said first corrugated layer are substantially perpendicular to said lines of corrugation in said second corrugated layer.

3. The self-corrugating laminate of claim 1, wherein the spacing between said spaced bond points along said horizontal bond lines is substantially the same as the spacing between said spaced bond points along said vertical bond lines.

4. The self-corrugating laminate of claim 1, wherein the spacing between said spaced bond points along said horizontal bond lines is greater than the spacing between said bond points along said vertical bond lines.

5. The self-corrugating laminate of claim 1, wherein the spacing between said bond points varies along at least one of said horizontal bond lines or said vertical bond lines.

6. The self-corrugating laminate of claim 1, wherein the shrinkable film layers each exhibit a percent shrinkage in the range of from 10 to 45 percent as measured along the primary axis of shrinkage of the shrinkable film layer.

7. The self-corrugating laminate of claim 1, wherein said first and second shrinkable film layers are each individually formed from one or more of a polyester, a copolyester, an acrylic, polyvinyl chloride, polylactic acid, a polycarbonate, a styrenic polymer, a polyolefin, a polyamide, a polyimide, a polyketone, a fluoropolymer, a polyacetal, a cellulose ester and a polysulfone.

8. The self-corrugating laminate of claim 1, wherein said bond points comprise an adhesive.

9. The self-corrugating laminate of claim 1, wherein said bond points comprise welds.

10. The self-corrugating laminate of claim 9, wherein said bond points further comprise creases or grooves.

11. A structural corrugate formed from the self-corrugating laminate of claim 1, said corrugate comprising a first corrugated layer and a second corrugated layer each with structural corrugations therein arranged along lines of corrugation; wherein at the interface of said first corrugated layer and said second corrugated layer said lines of corrugation in said first corrugated layer are substantially perpendicular to said lines of corrugation in said second corrugated layer.

12. A structural corrugate of claim 11 wherein the height of said structural corrugations in said first corrugated layer is approximately equal to the height of said structural corrugations in said second corrugated layer.

13. The structural corrugate of claim 11, wherein the height of said structural corrugations in said first corrugated layer is greater than the height of said structural corrugations in said second corrugated layer.

14. The structural corrugate of claim 11, wherein the height of said corrugations vary within at least one of said first corrugated layer and said second corrugated layer.

15. The structural corrugate of claim 11 characterized by aspect ratios of between 0.1 and 0.8.

16. A method of making a self-corrugating laminate comprising (i) providing first and second shrinkable film layers each with a primary axis of shrinkage and (ii) adhering said first and second shrinkable film layers such that said primary axis of shrinkage of said first shrinkable layer is substantially perpendicular to said primary axis of shrinkage of said second shrinkable film layer.

17. The method of claim 16 wherein said providing step includes feeding first and second shrinkable film layers from rolls to form a sheet assembly.

18. A structural corrugate formed from the self-corrugating laminate of claim 1.
